(19) United States
(12) Patent Application Publication
(10) Pub. No.: US 2014/0001102 A1
(43) Pub. Date: Jan. 2, 2014

(54) FLOTATION DEVICE COMPRISING A FLUID DISTRIBUTION ELEMENT FOR GENERATING A FLOW THAT IS DIRECTED AT THE FOAM COLLECTING UNIT

(71) Applicants: Stefan Blendinger, Furth (DE); Robert Fleck, Adelsdorf (DE); Gerold Franke, Numberg (DE); Lilla Grossmann, Erlangen (DE); Werner Hartmann, Weisendorf (DE)

(72) Inventors: Stefan Blendinger, Furth (DE); Robert Fleck, Adelsdorf (DE); Gerold Franke, Numberg (DE); Lilla Grossmann, Erlangen (DE); Werner Hartmann, Weisendorf (DE)

(73) Assignee: SIEMENS AKTIENGESELLSCHAFT, München (DE)

(21) Appl. No.: 14/005,204

(22) PCT Filed: Mar. 1, 2012
(86) PCT No.: PCT/EP12/53491

§ 371 Date: Sep. 13, 2013

(30) Foreign Application Priority Data
Mar. 15, 2011 (EP) 11158298.7

(51) Int. Cl. B03D 1/02; B03D 1/14

(52) U.S. Cl. CPC B03D 1/02; B03D 1/14
USPC 209/164; 209/168

(57) ABSTRACT

A housing of a flotation device has a flotation chamber with at least one inlet for a suspension. The flotation device has at least one foam collecting unit, arranged on an upper face of the housing, for receiving and discharging a foam product, and at least one fluid distribution element, provided above the at least one inlet in the flotation chamber, for generating a flow directed toward the at least one foam collecting unit. The vertical position of the at least one fluid distribution element is variable above the at least one inlet in the flotation chamber.

### CROSS REFERENCE TO RELATED APPLICATIONS

This application is the U.S. national stage of International Application No. PCT/EP2012/053491, filed Mar. 1, 2012 and claims the benefit thereof. The International Application claims the benefits of European Application No. 11158298 filed on Mar. 15, 2011, both applications are incorporated by reference herein in their entirety.

### BACKGROUND

Described below is a flotation device with a housing having a flotation chamber for receiving a suspension and at least one inlet for the suspension, and at least one froth collecting unit for receiving and discharging a froth product, the unit being disposed on an upper face of the housing. Also described is a method for discharging a froth product formed in such a flotation device, wherein the flotation chamber is at least partially filled with suspension, wherein the suspension is gassed and the froth product is formed from gas bubbles and solid particles attaching thereto, the froth product accumulating on the surface of the suspension and being discharged via the at least one froth collecting unit.

Flotation is a physical separation process for separating fine-grained mixtures of solids, e.g. ores and gangue, in an aqueous slurry or suspension using air bubbles, based on the different surface wettability of the particles contained in the suspension. It is used for the beneficiation of mineral resources and in the processing of mineral substances containing low to average amounts of a wanted component or valuable material, e.g. in the form of nonferrous metals, iron, rare earth metals and/or noble metals, as well as nonmetallic mineral resources.

For pneumatic flotation, a reagentized suspension of water and fine-grained solid material is generally introduced into a flotation chamber via at least one nozzle arrangement. The reagents are designed to have the effect of hydrophobizing in particular the valuable particles, i.e. particles of useful material to be separated out from the suspension. Xanthates are mainly used as reagents, particularly in order to selectively hydrophobize sulfidic ore particles. Gas, in particular air, which comes into contact with the hydrophobic particles in the suspension is fed to the at least one nozzle arrangement simultaneously with the suspension. The hydrophobic particles adhere to gas bubbles forming, so that the gas bubble formations, also known as aeroflocs, float and form the froth product on the surface of the suspension. The froth product is discharged into a collecting container and usually further concentrated.

The quality of the froth product, i.e. the separation success of the flotation method, is dependent, among other things, on the probability of collision between a hydrophobic particle and a gas bubble. The higher the collision probability, the greater the number of hydrophobic particles attaching to a gas bubble, rising to the surface and forming the froth product together with the particles.

A gas bubble diameter is less than about 5 mm and ranges in particular between 1 and 5 mm. Such small gas bubbles have a high specific surface and are therefore able to bind and entrain considerably more valuable material particles, particularly ore particles, per quantity of gas used than larger gas bubbles.

In general, larger diameter gas bubbles rise faster than smaller diameter gas bubbles. The smaller gas bubbles are picked up by the larger gas bubbles and combine with them to form even larger gas bubbles. This reduces the available specific surface of the gas bubbles in the suspension to which the particles of valuable material can be bound.

In the case of column-type flotation cells in which the flotation chamber's diameter is many times less than the height thereof, the distance that a gas bubble has to travel in the suspension or rather the flotation chamber in order to reach the surface of the suspension is particularly great. Because of the particularly long distance involved, particularly large gas bubbles are produced in the suspension, thereby reducing the specific discharge of valuable material particles from the suspension and therefore also the efficiency of the flotation cell.

In so-called hybrid flotation cells which are a combination of a pneumatic flotation cell and a column-type flotation cell, in particular larger valuable material particles with diameters in the region of 50 μm or more are not completely bound to the gas bubbles present and can therefore only be partially separated from the suspension. On the other hand, fines with particle diameters in the region of 20 μm or less are particularly well separated.

The output of a flotation device also depends on the efficiency with which the froth product formed is removed from the surface of the suspension. Thus in flotation devices so-called dead zones are often created in which only vertical transport processes take place between the suspension and the froth product floating on top. In the dead zones, the extraction of solid particles to be separated is reduced, as the bubbles of froth product stay there too long and even burst locally. Solid particles previously bound to such a burst bubble therefore fall back into the suspension and cannot be removed as froth product.

WO 2006/069995 A1 describes a pneumatic flotation cell having a housing enclosing a flotation chamber, at least one nozzle arrangement, here termed ejectors, for feeding suspension into the flotation chamber, and also at least a feed arrangement for feeding gas into the flotation chamber, referred to as aeration devices or aerators if air is used, and a collecting container for a froth product formed during flotation. The froth product is ideally forced away from the following froth, and runs in a product launder.

U.S. Pat. No. 6,095,336 and WO 1993/20945 A1 describe flotation cells having a network of permanently installed froth product launders designed to discharge the froth product as rapidly as possible at each location on the surface of the suspension.

In order to improve removal of the froth product, it has already been proposed in EP 613 725 A2 and in the published unexamined German patent application DE 2057195 to actively extract the froth product by suction.

RU 2397818 C1, U.S. Pat. No. 4,618,430, U.S. Pat. No. 1,374,447 or U.S. Pat. No. 1,952,727 describe flotation devices in which a gas stream or a gas/liquid stream is blown onto the surface of the suspension in the direction of a launder in order to drive the froth product in the direction of the froth product launder in an accelerated manner.

U.S. Pat. No. 6,926,154 B2 describes a flotation machine including a rotating device for froth product removal which is immersed at least partially in the froth and mechanically displaces it in the direction of the launder.

In the last mentioned active systems for accelerating the removal of the froth product, the shear forces applied to the froth product are mostly so high that this results in premature bursting of bubbles and therefore likewise to a reduced yield of froth product.

### SUMMARY

Described below is a flotation device with improved froth yield and a method for guiding a froth product formed in such a flotation device.

The flotation device has a housing with a flotation chamber for receiving a suspension, at least one inlet for the suspension, and at least one froth collecting unit for receiving and discharging a froth product, disposed on the top side of the housing. At least one fluid distribution element for delivering a fluid and generating a flow directed in the direction of the at least one froth collecting unit is positioned above the at least one inlet in the flotation chamber, the vertical position of the at least one fluid distribution element above the inlet in the flotation chamber being adjustable such that at least some of a fluid delivered by the at least one fluid distribution element is fed directly into the suspension adjacent to the surface of the suspension.

In the method for discharging a froth product formed in a flotation device, the flotation chamber is at least partially filled with suspension, the suspension is gassed and the froth product is formed from gas bubbles and solid particles attaching thereto, the froth product collecting on the surface of the suspension and being discharged via the at least one froth collecting unit, by using the at least one fluid distribution element to generate a flow in the direction of the at least one froth collecting unit and adjusting the vertical position of the at least one fluid distribution element in the flotation chamber as a function of the suspension fill level of the flotation chamber such that at least some of the fluid delivered by the at least one fluid distribution element flows directly into the suspension adjacent to the surface of the suspension.

An advantage of the flotation device described below is that the vertical position of the at least one fluid distribution element above the inlet to the flotation chamber is variable and therefore adjustable to a suspension fill level in the upper part of the flotation chamber. As a result, a fluid distribution element can have optimum effect at the boundary layer or across the boundary layer between froth and suspension, thereby allowing particularly gentle acceleration of the froth product in the direction of the froth collecting unit. The froth and/or the suspension is displaced by the fluid flowing out of a fluid distribution element below the surface of the suspension and pushed in the direction of a froth collecting unit. This can take place at relatively low fluid outflow rates, so that no bubbles burst prematurely.

Fluid distribution elements can generally be disposed completely below the surface of the suspension adjacent to the surface so that all the fluid delivered by them flows directly into the suspension.

A fluid distribution element is disposed in particular adjacent to a region in the flotation chamber in which, without the fluid distribution element, a dead zone would be located in which only vertical transport processes take place between the suspension and the froth product floating on top of it.

Either gas, in particular air, can be used as a fluid, or a liquid, in particular water, can be fed in.

The vertical position of the at least one fluid distribution element may be adjusted such that at least some of a fluid delivered by the at least one fluid distribution element flows directly into the suspension adjacent to the surface of the suspension.

If gas is used, it is delivered in the region of the froth and/or in the region of the suspension. In this case additional bubbles are formed which pick up sinking hydrophobic solid particles and carry them upward again. If a liquid is used, it may be injected only in the region of the suspension, as charging the froth product with liquid may result in undesirable bursting of bubbles.

In an embodiment, fluid distribution elements can be simultaneously present for introducing gas and/or for introducing liquid.

It has proved effective for the flotation chamber to have a vertical central axis and for the at least one froth collecting unit to be annular and be disposed concentrically to the central axis, wherein the at least one fluid distribution element is designed to produce a flow directed away from the central axis in the direction of the at least one annular froth collecting unit. Here a plurality of annular froth collecting units disposed concentrically to one another can be present to which at least one fluid distribution element is assigned in each case. The flotation chamber can have different outline shapes, such as a rectangle, a circle, an ellipse, etc.

The flotation machine may be a pneumatic flotation cell, a column flotation cell or a hybrid flotation cell in which both types are combined.

The at least one fluid distribution element may be designed to produce a flow directed radially away from the central axis of the flotation chamber. As a result, the path that a bubble of froth product has to travel is minimized. The time taken to reach the froth collecting unit and therefore the risk of a bubble bursting during this time is likewise minimized. Alternatively, however, a flow directed obliquely to a separating edge between flotation chamber and froth collecting unit can also be produced.

The flotation device has in particular at least one positioning device which is designed to automatically vary the vertical position of the at least one fluid distribution element as a function of the suspension fill level of the flotation chamber. It is thus ensured at all times that a locally optimum supply of fluid takes place in the direction of the froth product and/or suspension. This is to be understood on the one hand as an arrangement including a float as a positioning device which floats on the surface of the suspension and ensures constant, automatic positioning of the fluid distribution element with respect to the surface of the suspension. Alternatively, however, vertical height adjustment can take place via an electrically powered positioning device, which also makes it possible to vary how far a fluid distribution element is to be immersed in the suspension for a particular fill level. As a result, different immersion depths of a fluid distribution element in the suspension for different fill levels can be implemented.

In particular, there is provided at least one open- or closed-loop control device for controlling a fluid outflow rate from the at least one fluid distribution element and/or the vertical position of the at least one fluid distribution element. the fluid outflow rate can be adjusted via the volumetric fluid flow rate and/or the fluid pressure.

In addition, there may be provided at least one first sensor for determining at least one characteristic of the froth product from the group:
froth product color,
froth product bubble size,
froth product bubble shape,
decay rate of froth product bubbles,
transport velocity of froth product bubbles. For this purpose the first sensor may be implemented as an optical sensor. Online monitoring of these characteristics which provide information about the quality of the froth product enables the vertical position of a fluid distribution element or the fluid outflow rate to be selectively optimized. In particular, the first sensor is installed in a region [such] that froth behavior can be monitored in a zone which—without the fluid distribution element—is to be regarded as a dead zone.

For example, if it is ascertained that too many bubbles are already bursting on the way to the froth collecting unit, the fluid outflow rate and/or the quantity of fluid is reduced and an even gentler flow is produced in order to treat the bubbles more carefully and extend their lives.

The purpose of closed-loop control is to adjust the fluid flow such that a high froth product yield is achieved while maximizing froth product quality. This point is termed “optimum froth recovery” or even “peak air recovery”.

The color of the froth product indicates, for example, how heavily the gas bubbles are loaded with particles of valuable material to be recovered. The higher the loading of the gas bubbles with particles of valuable material, the more intense the color of the froth product. If the froth product is light in color, e.g. in the case of sulfidic ores, it must be assumed that the fluid outflow rate or the fluid flow is too great and therefore the concentration of valuable material particles to be recovered, e.g. of copper or molybdenum sulfides, in the froth product is too low. An undesirable amount of gangue material is being introduced into the froth product, causing its quality to assume impermissibly low values.

Accordingly, in the case of an excessively light colored froth product, the fluid flow and/or the outflow rate thereof is reduced until the required froth product color and therefore the required quality is achieved again.

Conversely, in this case, if the froth product color were too intense, the amount of fluid and/or the outflow rate thereof would be increased in order to maximize the yield of valuable material particles to be recovered.

Similarly, large bubbles in the froth product indicate that the residence time of the bubbles in the froth product is too long and bubbles with lower specific surface have been formed from small bubbles due to bubble coalescence, thereby reducing the yield. Accordingly, if comparatively large bubbles are present in the froth product, the amount of fluid and/or fluid outflow rate is increased in order to reduce the residence time of the bubbles in the froth product and therefore reduce bubble coalescence, and vice versa.

Depending on the respective flotation process, the shape of individual bubbles in the froth product can be used to control the quantity of fluid and/or fluid outflow rate and therefore of the critical process parameters yield and quality. Whereas for many processes a circular bubble shape in the froth may be preferred, in other flotation processes a polygonal bubble structure may be optimum for the process. Depending on the respective process, the quantity of fluid and/or the outflow rate thereof is therefore controlled such that the more favorable bubble shape in respect of yield and quality is produced.

It has also proved effective for at least one second sensor to be present for determining the suspension fill level of the flotation chamber. Selective optimization of the vertical position of a fluid distribution element or of the fluid outflow rate is likewise possible via online fill level measurement.

The at least one first sensor and/or the at least one second sensor may be connected to the at least one open- and closed-loop control device. This allows cost-effective, fully automatic operation of the flotation device with high froth recovery.

An outflow rate of a fluid delivered by the at least one fluid distribution element and/or the quantity thereof may be controlled in an open- or closed-loop manner on the basis of at least one characteristic of the froth product from the group:
froth product color,
froth product bubble size,
froth product bubble shape,
decay rate of froth product bubbles,
transport velocity of froth product bubbles.

In addition, a vertical position of the at least one fluid distribution element may be controlled in an open- or closed-loop manner on the basis of at least one characteristic of the froth product from the group:
froth product color,
froth product bubble size,
froth product bubble shape,
decay rate of froth product bubbles,
transport velocity of froth product bubbles.

The open- or closed-loop control device consequently allows optimum froth recovery at all times under changing input parameters in respect of the fill level of the flotation chamber and the quality of the froth product.

In an embodiment, the at least one fluid distribution element includes an open-porous component via which the fluid is delivered. The open-porous component is in particular constituted by a metal or plastic foam material. Alternatively, the fluid distribution element can also be a pipe or hose with fluid outlet openings, e.g. in the form of slits, holes or fluid-permeable diaphragms.

The at least one fluid distribution element may be designed such that a laminar flow is produced in the direction of the at least one froth collecting unit. Swirling is avoided as far as possible, as it unnecessarily increases the residence time of the froth product on the surface of the suspension and places more mechanical stress on the bubbles so that more bubbles burst prematurely and altogether less froth product can be recovered.

The flotation device may be used for flotation of solid particles of a valuable material, particularly ore mineral, from a suspension having a solids content ranging from 20 to 50% with the formation of a froth product. Under such conditions, the efficiency of a flotation device can be considerably increased by at least one fluid distribution element.

### BRIEF DESCRIPTION OF THE DRAWINGS

These and other aspects and advantages will become more apparent and more readily appreciated from the following description of the exemplary embodiments, taken in conjunction with the accompanying drawings of which FIGS. 1 to 7 are intended to schematically explain examples of flotation devices and the way they work. Thus:

FIG. 1 is a schematic block diagram of a first flotation device;

FIG. 2 is a schematic block diagram of a second flotation device;

FIG. 3 is a longitudinal section through a third flotation device;

FIG. 4 is a top view of the third flotation device;

FIG. 5 is a detail of a flotation chamber section, similar to FIG. 3 with dead zones depicted;

FIG. 6 is a detail of a flotation chamber section, similar to FIG. 5 with two fluid distribution elements;

FIG. 7 is a longitudinal section through a fourth flotation device.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

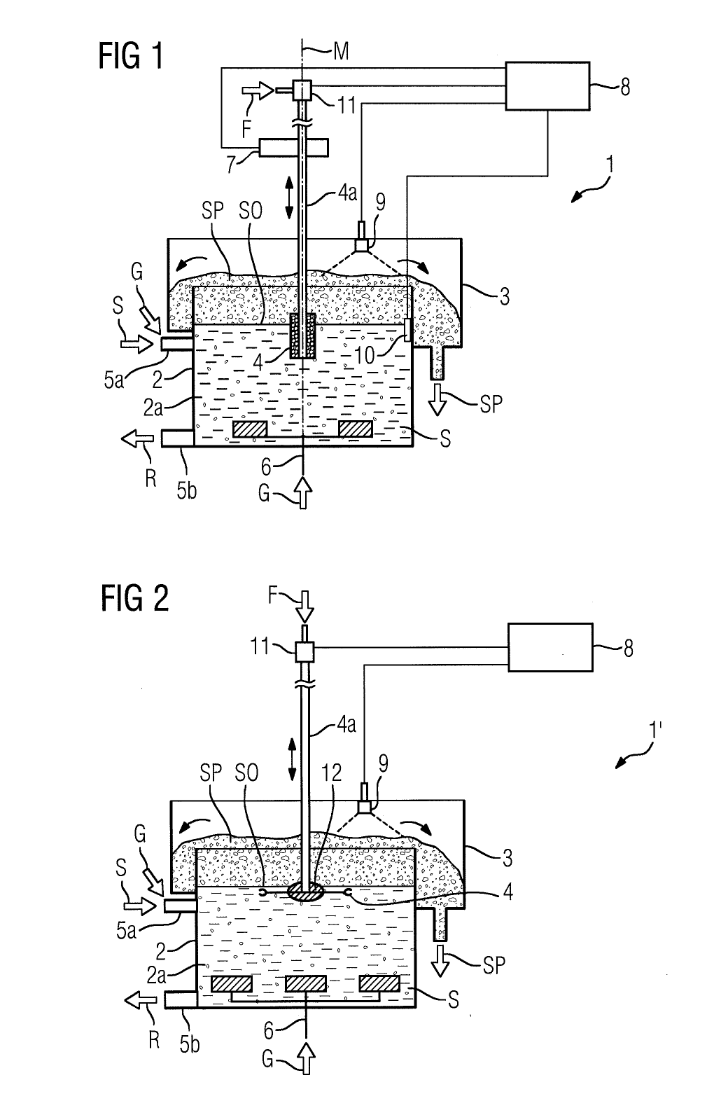

FIG. 1 schematically illustrates a first flotation device with a housing 2 having a flotation chamber 2a for receiving a suspension S and at least one annular froth collecting unit 3 for receiving and discharging a froth product SP, the unit being disposed on top of the housing 2. The housing 2 is depicted in longitudinal section for the sake of clarity. The suspension S is introduced into the flotation chamber 2a, optionally with the addition of gas, via an inlet 5a and mixed with gas bubbles, in particular air bubbles, rising from the bottom of the flotation chamber 2a. The gas bubbles in the suspension S are created by a gassing element 6. Hydrophobic solid particles from the suspension S attach to the gas bubbles so that the gas bubble formations, also known as aeroflocs, float and form the froth product SP at the surface S0 of the suspension S. The froth product SP flows over the edge of the housing (see arrows) into the froth collecting unit 3. Remaining residual pulp R is discharged from the flotation chamber 2a via an outlet 5b.

A fluid distribution element 4 for producing, in the flotation chamber 2a, a flow directed essentially in the direction of the froth collecting unit 3 is also present, the vertical position of which in the flotation chamber 2a can be varied by a positioning device 7. Here the fluid distribution element 4 is disposed both above and below the boundary layer or surface S0 between suspension S and froth product SP. The fluid distribution element 4 is made of an open-porous metal foam and has a supply line 4a through which the fluid is transported and on which the positioning device 7 engages. The fluid distribution element 4 is designed to produce a flow directed radially away from the central axis M of the flotation chamber 2a.

An open- or closed-loop control device 8 is connected to a first sensor 9 for optically determining the decay rate of the bubbles of froth product SP and to a second sensor 10 for determining the fill level of suspension S in the flotation chamber 2a. The open- and closed-loop control device 8 is additionally connected to a valve arrangement 11 via which the volumetric flow rate and/or pressure of the fluid F can be set and consequently the outflow rate of fluid F from the fluid distribution element 4 can be influenced as a function of the decay rate of the bubbles of froth product SP.

The vertical setpoint position of the fluid distribution element 4 is communicated as a function of the fill level and/or the decay rate via the open- or closed-loop control device to the positioning device 7 which adjusts the vertical setpoint position accordingly.

The creation of dead zones can be reliably prevented and a high froth output achieved.

FIG. 2 shows a second flotation device 1′. The same reference characters as in FIG. 1 are used to denote identical elements. In contrast to FIG. 1, a fluid distribution element 4 in the form of an annularly disposed hose is present here which has slits on its side facing the housing 2 in order to allow the fluid F to pass through in the direction of the housing 2. In order to automatically adjust the vertical position of the fluid distribution element 4 in respect of the fill level of the flotation chamber 2a, a float 12 is provided which moves up or down with the surface S0 of the suspension S.

The open- and closed-loop control device 8 is once again connected to a valve arrangement 11 via which the volumetric flow rate and/or pressure of the fluid F can be adjusted, thereby influencing the outflow rate of fluid F from the fluid distribution element 4 as a function of decay rate of the bubbles of froth product SP.

The creation of dead zones can be reliably prevented and a high froth output achieved.

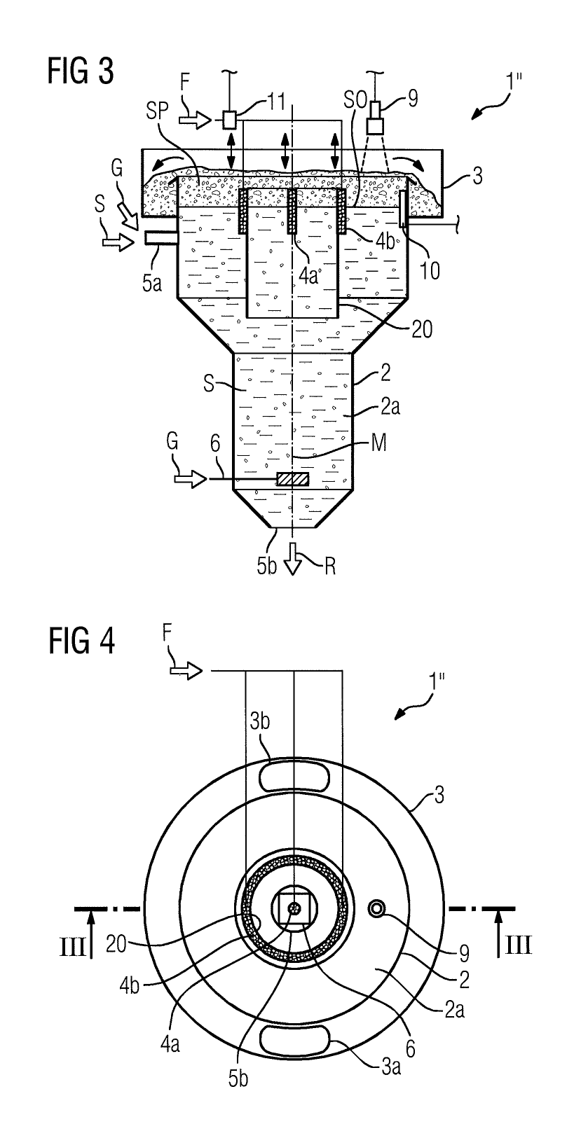

FIG. 3 schematically illustrates a third flotation device 1″ in longitudinal section. This is a column flotation cell which, when operated using air for gassing the suspension, is termed a hybrid flotation cell. The same reference characters as in FIGS. 1 and 2 are used to denote identical elements. The housing 2 is enlarged in the upper section and suspension S and gas G are injected via the inlet 5a. In the enlarged upper section of the housing 2 a cylindrical insert 20 is present which separates a pneumatic flotation stage outside the insert 20 from an additional flotation stage inside the insert 20.

The suspension S laden with gas G is injected at high pressure into the flotation chamber 2a. The pressure drop in the flotation chamber 2a causes gas bubbles to form which are then used for flotation. This mechanism is known as dissolved air flotation.

In the exemplary embodiment, the additional flotation stage involves so-called column flotation. For this purpose, a gassing element 6 for feeding gas G which is implemented e.g. as an aerator is disposed in the lower section of the flotation chamber 2a where an outlet 5b for residual pulp R is also provided. This produces gas bubbles that are suitable for attaching particles of valuable material in the lower section of the flotation device 1″.

By combining these two flotation stages, a higher yield is achieved than with many other types of flotation cell which only employ one flotation stage inside a flotation device.

A rod-shaped first fluid distribution element 4a is disposed centrally in the insert 20 and is used to introduce fluid F in the region of the surface S0 of the suspension S, the fluid F flowing radially away from the central axis M.

An annular second fluid distribution element 4b surrounds the insert 20 and is used to introduce fluid F in the region of the surface S0 of the suspension S, the fluid F flowing radially outward in the direction of the vessel 2. The vertical position of the fluid distribution elements 4a, 4b is variable, which is here indicated merely by double arrows. Not shown for the sake of clarity is the open- and closed-loop control device 8 to which the first sensor 9, the second sensor 10, the valve arrangement 11 and the positioning device 7 (likewise not shown) are connected. In this respect reference is made to FIGS. 1 and 2.

FIG. 4 shows a plan view of the third flotation device 1″, wherein the design of the annular froth collector unit 3, the insert 20 and the annular second fluid distribution element 4b are better illustrated. The froth collector unit 3 has two outflow regions 3a, 3b for discharging the froth product SP.

FIG. 5 shows a detail of a longitudinal section through a known flotation device without fluid distribution element, similar in principle to FIG. 3 in the upper region in which the insert 20 is located, between the center line M and the housing 2. The same reference characters as in FIGS. 1 to 4 are used to denote identical elements. The assumed flow conditions in the froth product SP are indicated. In the flotation chamber section shown, two dead zones TZ₁, TZ₂ are formed in which only vertical transport processes take place between the suspension S and the froth product SP floating on top of it. The first of the two dead zones TZ₁ is located in the region of the central axis M. The second of the two dead zones TZ₂ is formed annularly around the insert 20. The recovery of solid particles to be separated is reduced in the dead zones TZ₁, TZ₂, as the bubbles of froth product SP remain too long there and even burst locally. Solid particles previously bound to such a burst bubble therefore sink back into the suspension S and cannot be extracted as froth product SP. In lift zones Hz₁, HZ₂, on the other hand, a bubble rises and enters a transport zone TR₁, TR₂ in which it is transported away in the direction of the froth collecting unit 3 (not shown here).

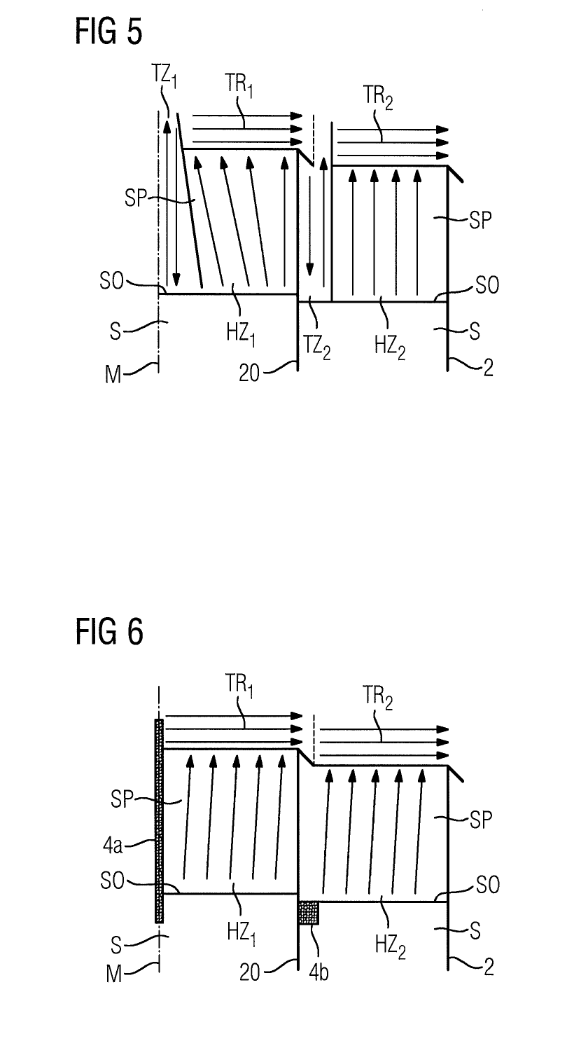

FIG. 6 shows the detail from FIG. 5, but now with two fluid distribution elements 4a, 4b present, similarly to FIG. 3. A first fluid distribution element 4a is rod-shaped and disposed in the region of the central axis M, it being partially immersed in the suspension S. A second fluid distribution element 4b is ring-shaped and surrounds the insert 20, wherein it is completely immersed in the suspension S. The same reference characters as in FIGS. 1 to 5 are used to denote identical elements. The assumed flow conditions in the froth product SP are indicated. Due to the fluid flowing through the fluid distribution elements 4a, 4b, dead zones in which only vertical transport processes take place between the suspension S and the froth product SP floating on top of it are no longer created in the flotation chamber section shown. The dead zones previously present have now likewise become lift zones HZ₁, HZ₂, so that essentially more froth product SP can be discharged than hitherto. The recovery of solid particles to be separated is significantly increased.

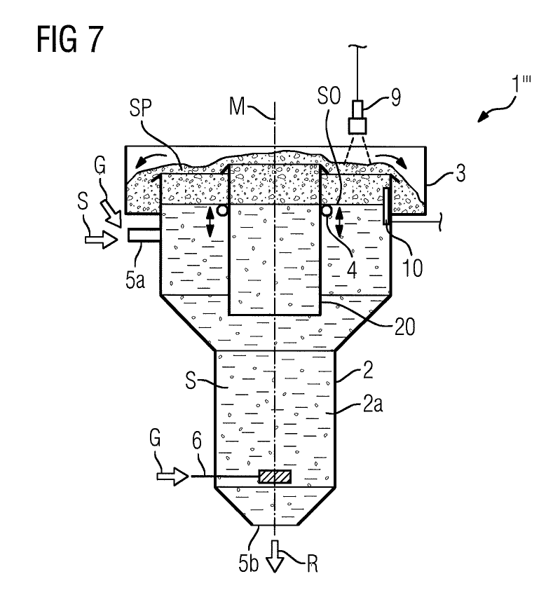

FIG. 7 shows a longitudinal cross section through a fourth flotation device 1″. This is a column flotation cell as in FIG. 3 which, when operated with air for gassing the suspension S, is termed a hybrid flotation cell. The same reference characters as in FIGS. 1 to 6 are used to denote identical elements.

An annular fluid distribution element 4 surrounds the insert 20 and is used to introduce fluid F in the region of the surface S0 of the suspension S, the fluid F flowing out radially in the direction of the vessel 2. The vertical position of the fluid distribution elements 4 is variable, which is indicated here merely by the double arrows. Omitted here for the sake of clarity is the representation of the open- and closed-loop control device 8 to which the first sensor 9, the second sensor 10, the valve arrangement 11 and the positioning device 7 (likewise not shown) for vertical position adjustment of the fluid distribution element 4 are connected. In this respect reference is made to FIGS. 1 and 2.

Fluid distribution elements can generally be disposed completely below the surface of the suspension adjacent to the surface, so that all the fluid delivered via them flows directly into the suspension.

FIGS. 1 to 7 merely show examples of a flotation device. Thus, other shapes in respect of the vessel, the fluid distribution element, the gassing element, the froth collecting unit, the insert, etc. may well be present. The number of inlets, outlets, fluid distribution elements, first and/or second sensors, gassing elements, open- or closed-loop control devices, positioning devices etc. can also be varied without departing from the basic concept of the invention.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. A flotation device, comprising:
a housing having a flotation chamber receiving a suspension with a surface, and at least one inlet for the suspension;
at least one froth collecting unit, disposed on top of the housing, receiving and discharging a froth product; and
at least one fluid distribution element, disposed at an adjustable vertical position above the at least one inlet in the flotation chamber, delivering a fluid and generating a flow directed toward the at least one froth collecting unit, at least some of the fluid being injected directly into the suspension adjacent to the surface of the suspension.

16. The flotation device as claimed in claim 15,
wherein the flotation chamber has a vertical central axis;
wherein the at least one froth collecting unit is annular and disposed concentrically to the central axis of the flotation chamber, and
wherein the flow generated by the at least one fluid distribution element toward the at least one froth collecting unit is directed away from the central axis of the flotation chamber.

17. The flotation device as claimed in claim 16, wherein the at least one fluid distribution element generates a flow directed radially away from the central axis.

18. The flotation device as claimed in claim 15, further comprising at least one positioning device automatically adjusting the vertical position of the at least one fluid distribution element as a function of a fill level of the suspension in the flotation chamber.

19. The flotation device as claimed in claim 18, further comprising at least one open- or closed-loop control device controlling at least one of an outflow rate of the fluid from the at least one fluid distribution element and the vertical position of the at least one fluid distribution element.

20. The flotation device as claimed in claim 19, further comprising at least one first sensor, connected to the at least one open- or closed-loop control device, determining at least one characteristic of the froth product selected from the group consisting of color of the froth product, size of bubbles of the froth product, shape of the bubbles of the froth product, decay rate of the bubbles of the froth product, and transport velocity of the bubbles of the froth product.

21. The flotation device as claimed in claim 20, further comprising at least one second sensor, connected to the at least one open- or closed-loop control device, determining the fill level of the suspension in the flotation chamber.

22. A method for discharging a froth product formed in a flotation device having a housing with a flotation chamber, comprising:
at least partially filling the flotation chamber with a suspension from at least one inlet in the housing;
gassing the suspension to form the froth product from gas bubbles and solid particles attached thereto, the froth product accumulating on a surface of the suspension;
adjusting a vertical position of at least one fluid distribution element in the flotation chamber as a function of a fill level of the suspension in the flotation chamber;
producing, by the at least one fluid distribution element, a flow of a fluid toward at least one froth collecting unit disposed on top of the housing, at least some of the fluid being injected directly into the suspension adjacent to the surface of the suspension; and
discharging the froth product via the at least one froth collecting unit.

23. The method as claimed in claim 22, wherein said adjusting of the vertical position of the at least one fluid distribution element and said producing of the flow of the fluid prevents formation of a dead zone in which only vertical transport processes between the suspension and the froth product floating thereupon take place.

24. The method as claimed in claim 22, wherein said producing of the flow of the fluid by the at least one fluid distribution element generates a laminar flow toward the at least one froth collecting unit.

25. The method as claimed in claim 22, further comprising controlling an outflow rate and/or a volume of the flow of the fluid produced by the at least one fluid distribution element in an open- or closed-loop manner based on at least one characteristic of the froth product selected from the group consisting of color of the froth product, size of bubbles of the froth product, shape of the bubbles of the froth product, decay rate of the bubbles of the froth product, and transport velocity of the bubbles of the froth product.

26. The method as claimed in claim 22, wherein said adjusting of the vertical position of the at least one fluid distribution element is controlled in an open- or closed-loop manner based on at least one characteristic of the froth product selected from the group consisting of the color of the froth product, the size of the bubbles of froth product, the shape of the bubbles of the froth product, the decay rate of the bubbles of the froth product, and the transport velocity of the bubbles of the froth product.

27. The method as claimed in claim 22, wherein the solid particles include an ore mineral and the suspension has a solids content ranging from 20% to 50%.
